(19) United States
(12) Patent Application Publication
(10) Pub. No.: US 2012/0322032 A1
(43) Pub. Date: Dec. 20, 2012

(54) METHODS AND SYSTEMS FOR ELECTRONIC MEAL PLANNING

(75) Inventor: Ryan Smith, Portland, OR (US)

(73) Assignee: SPINNING PLATES, LLC, Portland, OR (US)

(21) Appl. No.: 13/163,585

(22) Filed: Jun. 17, 2011

(51) Int. Cl. G09B 19/00

(52) U.S. Cl. 434/127

(57) ABSTRACT

Various methods and systems are provided for meal planning. In one example, a method for meal planning includes receiving a user's meal preferences and automatically generating a meal plan including a plurality of separate meals based on the user's meal preferences.

### FIELD

The present invention relates in general to an electronic cookbook, and in particular to a method and system for planning upcoming meals and shopping for ingredients. More particularly, the present invention records user preferences for given recipes or sets of recipes, and plans upcoming meals according to those preferences.

### BACKGROUND AND SUMMARY

Planning meals several days in advance is widely considered to be a desirable approach to home economics, often resulting in: higher-quality meals, more organized shopping, and overall time savings. For years people have used paper templates for planning meals, writing in the names of recipes by day and meal slot, using traditional cookbooks, magazines, or recipe cards as sources of recipes. People increasingly look to computing devices (laptop or desktop computers, smartphones, websites) to simplify and automate certain recurring tasks, including the process of meal planning and shopping list management.

A number of publications, websites, and other computing devices provide capabilities of meal planning. Some publications, such as Real Simple magazine, provide a designated set of recipes for each day, which may also include a shopping list. Some websites which provide recipes (such as bigoven.com) offer the functionality of planning meals for upcoming days, based on a user's manual selection of each recipe, populating one meal at a time. Such a manual (step-wise) electronic meal-planning capability is also offered by certain computer device applications, such as the “Meal Board” application. Also, some websites (e.g., mealmixer.com and foodonthetable.com) provide an automated meal plan for upcoming dates, based upon general criteria specified by the user (calorie count criteria, food allergens to avoid, etc.).

However, the inventor herein has recognized that the foregoing approaches to meal planning tend to have at least one of two common limitations. First, they generally require time to be spent up-front to create a meal plan every few days, which for busy people means that they will frequently fail to make time. Second, the examples that can reduce advance planning (e.g., a pre-printed meal plan from a magazine) are not customized to the user's particular preferences.

At least some of the above issues may be addressed by a method for meal planning, comprising: receiving a digital representation of a user's meal preferences; and automatically generating a meal plan including a plurality of separate meals based on the user's meal preferences. For example, meal-specific preferences, including meal-specific constraints, may be used in planning upcoming meals that are displayed to the user

In this way, it is possible to make the process of meal planning more efficient (with little to no time spent choosing upcoming meals), while at the same time have the resulting meals more suited to the user's customized preferences.

In one example, it is possible to separate the process of recipe management (decisions about which recipes the user likes, how frequently to prepare them, what seasons of the year they are most appropriate) from the week-by-week process of menu planning and shopping. By enabling the user to address these two activities independently, users can be thoughtful and forward-thinking when managing recipe preferences, while operating very efficiently on a weekly basis as they shop and prepare meals. Similarly, such an approach simplifies and speeds the process of shopping for the ingredients required for the generated meal plan.

In another example, a method for meal planning comprises receiving a digital representation of a user's meal slot timing preferences, repetition constraints, preparation time constraints, and/or frequency preferences; and automatically generating an electronic meal plan based on the user's preferences and/or constraints.

For example, a plurality of meals in the meal plan may be selected based not only on whether a recipe of a meal uses currently available fresh ingredients for a particular time of year (e.g., lettuce in the spring), but also how often a user has selected a particular recipe or meal to reoccur in meal plans. Furthermore, the approach may also generate a shopping list based on a generated upcoming meal plan, which may be used in the shopping process in various ways (taking a printed shopping list to the store, taking the computing device to the store and designating items as purchased, shopping for items on a website, etc.).

In this way, it is possible to capture user preferences, and provide an automated meal plan suited to the user's preferences, with a corresponding shopping list, such that little to no time is required to be spent by the user to create the meal plan and shopping list.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present application may be better understood from reading the following description of non-limiting embodiments, with reference to the attached drawings:

FIG. 1 shows a schematic diagram of an overall system for implementing automatic meal planning based on user preferences.

FIG. 2 shows a schematic diagram of a device architecture for meal planning.

FIGS. 3-4 and 6-7 are example routines for carrying out a meal planning routine.

FIG. 5 is a schematic representation of meal planning preferences and constraints.

FIG. 8 shows a meal planning data architecture

### DETAILED DESCRIPTION

The following description relates to meal planning systems and methods that utilize user-customizable meal-specific preferences to improve automatic generation of a meal plan. In one embodiment, the meal planning approach integrates the following home economic functions to provide timesavings and/or improved meal choice and quality: Recipe Management, Meal Planning, and Grocery Shopping List Generation.

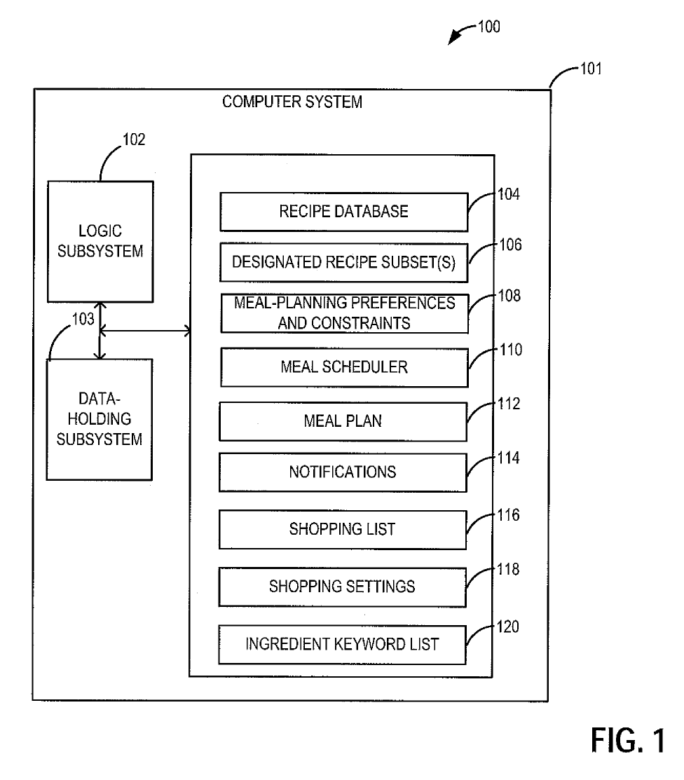

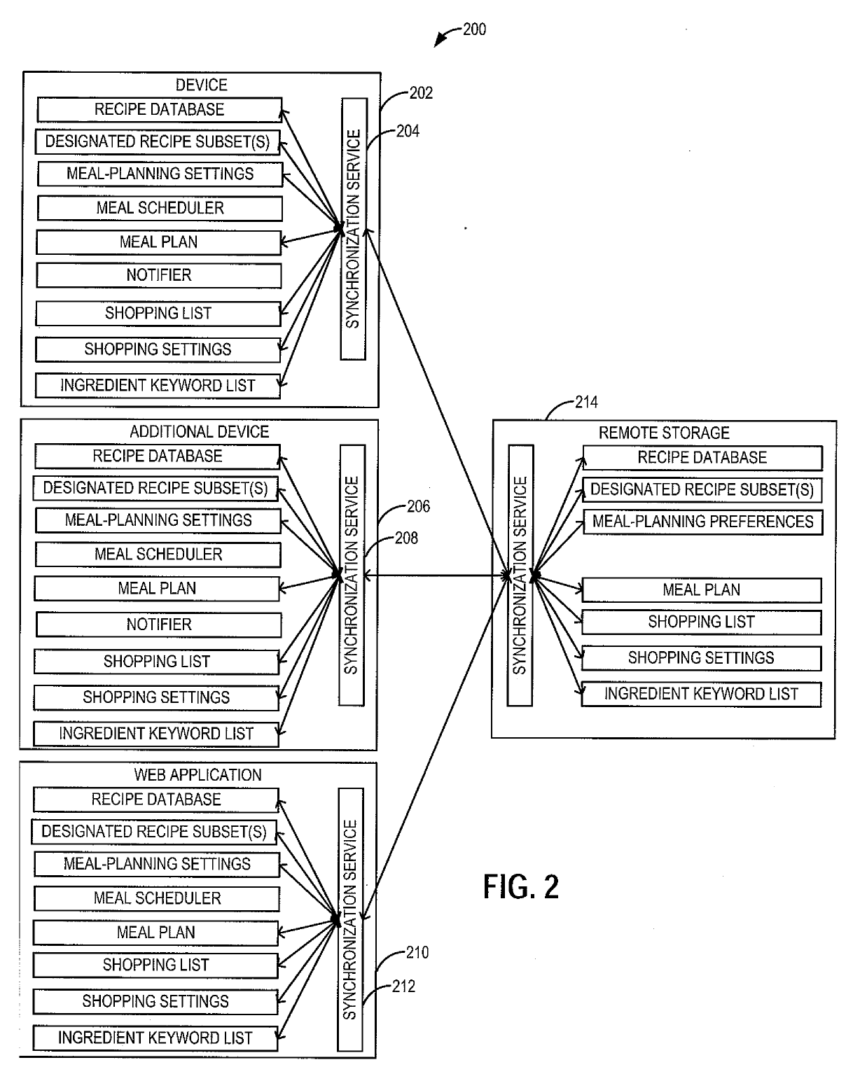

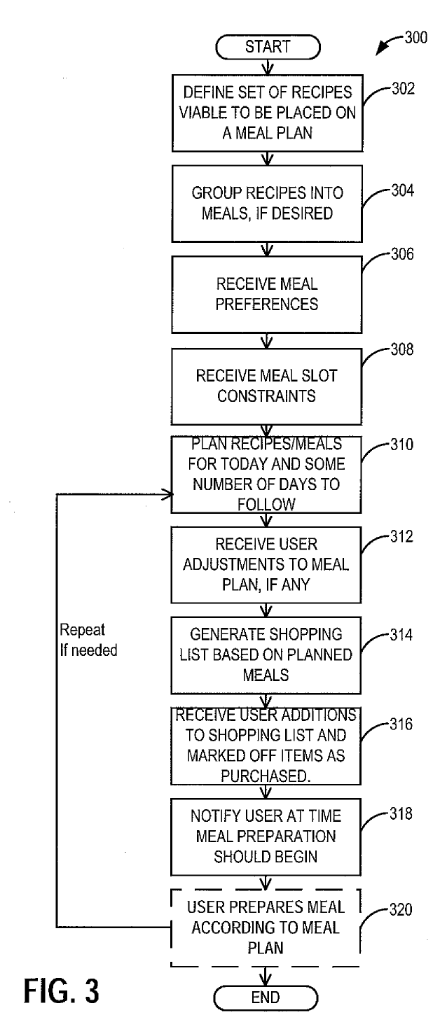

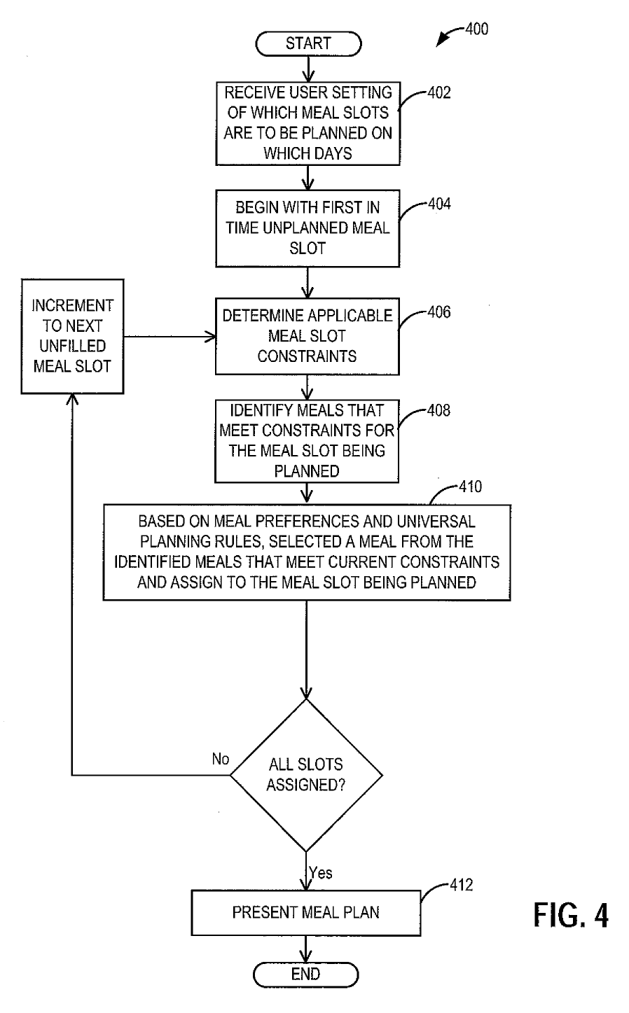

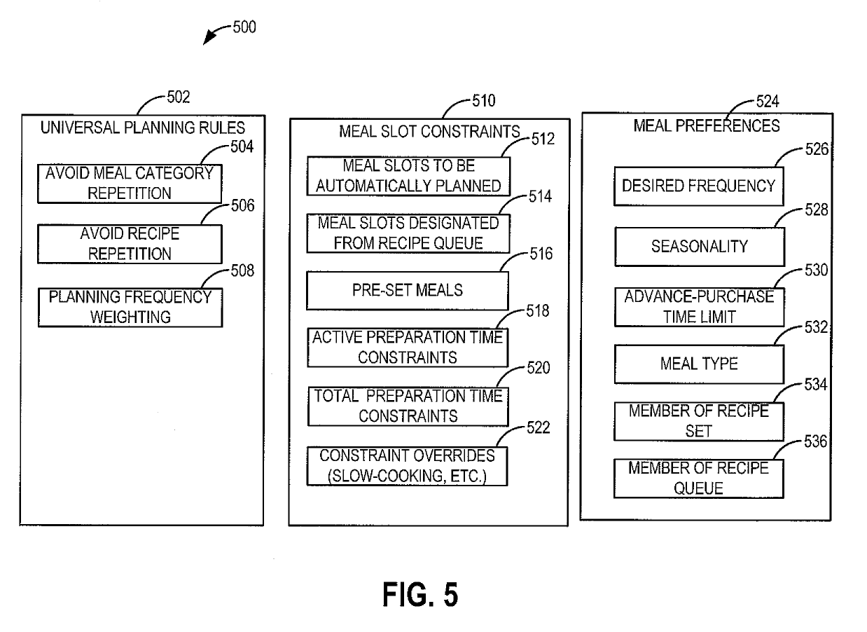

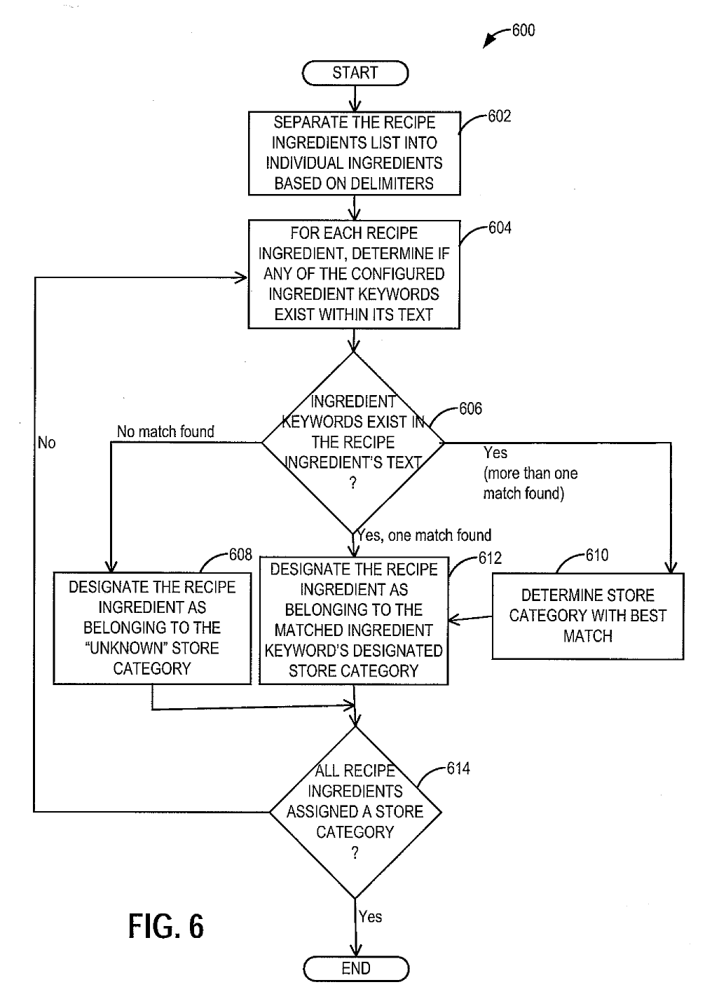

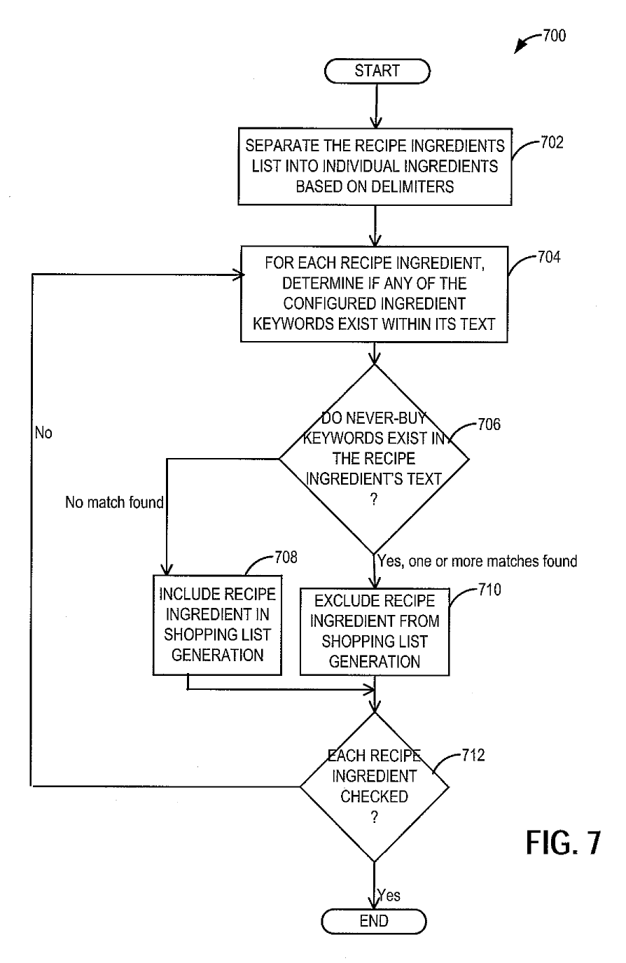

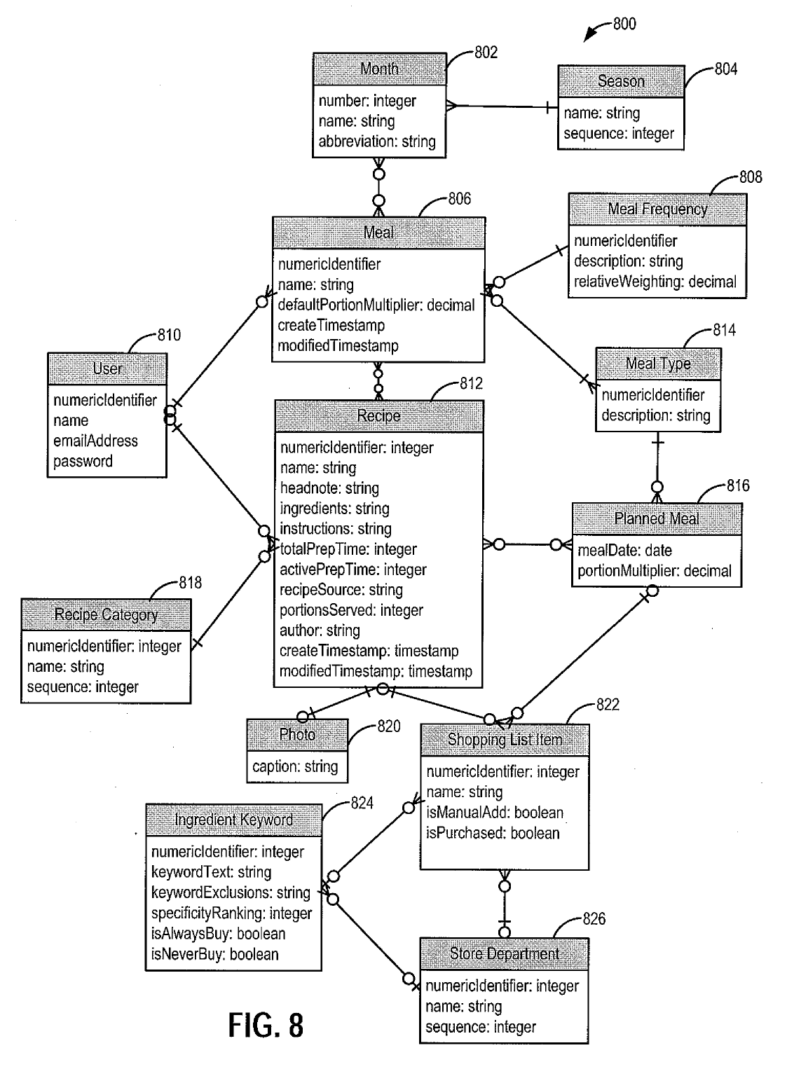

FIG. 1 provides a schematic view of various components of the meal planning system, which may be implemented through one or more devices, such as the example architecture set forth in FIG. 2. As described by the example routines of FIGS. 3-4, the meal planning system caries out a meal planning routine that selects among various recipes to generate a user-customized meal plan having a plurality of recipes for a given set of meals (e.g., three meals a day, or dinner each night for a plurality of upcoming days, etc.). Each meal is or may include a collection of one or more recipes intended to be served together. The generated meal plan is based on meal-specific user preferences and/or meal slot constraints as set forth in FIG. 5. The user preferences may constrain the selection of certain recipes to be included in meal plans on certain days of the week or certain seasons of the calendar year, for example. Additionally, the user preferences may constrain the selection of certain meals based on their recipes, ingredients, and/or their relation to other meals (such as where one recipe should or should not be planned adjacent to another recipe in a meal plan). Further, based on the generated meal plan, a shopping list can be generated as illustrated in FIGS. 6-7. For example, a shopping list may be generated based on the meal plan, where the shopping list may be used in the shopping process in various ways (taking a printed shopping list to the store, taking the computing device to the store and designating items as purchased, shopping for items on a website, etc.). An example data structure to implement the meal planning approach is set forth in FIG. 8.

Referring now to FIG. 1, it shows an example meal planning system 100 implemented via a computer system 101, which may include a digital logic subsystem 102 and data-holding subsystem 103. Computer system 101 may include one or a set of one or more computers interacting, such as via a wired or wireless network, or any other communication protocol. Logic subsystem 102 may include one or more physical devices configured to execute one or more instructions related to meal planning, such as described in FIGS. 3-6. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration. The logic subsystem may further include a graphical user interface for displaying information to the user (such as a generated meal plan or shopping list), and receiving digital information from the user (such as meal settings, preferences, etc.). It should be appreciated that information received from the user can be in various digital forms that represent a user's inputs. For example, the user may input checks to checkboxes, enter text, select and/or move pictorial icons, etc., and each of these or other such inputs can be a digital representation of user inputs, such as user preferences related to meal planning. Further, it should be appreciated that the system can transform the display presented to the user based on various methods and routines as described herein, in order to display an automatically generated electronic meal plan. The display may be text based, pictorial, etc. Further, the system may generate audio sounds to transmit the automatically generated electronic meal plan to the user.

Data-holding subsystem 103 may include one or more physical, non-transitory, devices configured to hold data and/or instructions executable by the logic subsystem to implement the herein described methods and processes. When such methods and processes are implemented, the state of data-holding subsystem 102 may be transformed (e.g., to hold different data).

Data-holding subsystem 103 may include removable media and/or built-in devices. Data-holding subsystem 103 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 102 may include devices with one or more of the following characteristics: volatile, nonvolatile, dynamic, static, read/write, read-only, random access, sequential access, location addressable, file addressable, and content addressable. In some embodiments, logic subsystem 102 and data-holding subsystem 103 may be integrated into one or more common devices, such as an application specific integrated circuit or a system on a chip.

Computer system 101, via either or both of the subsystems 102 and 103, may include a plurality of components 104-120, including a recipe database 104 that includes a collection of recipes. The recipe database 104 may store the recipes in various forms, including grouping of individual recipes into meals, which serves as the content used to create meal plans as described below. The recipe database may be supplied with the system, created by a user, or a combination of the two.

A recipe sets forth a detailed method of cooking or otherwise preparing food, and may include a title, a list of one or more ingredients, and a set of detailed instructions to be followed to create the finished dish. An example recipe for Hard-Boiled Eggs may therefore include ingredients (e.g., 8-12 large eggs), and instructions (e.g., Place the eggs in a large pot and add just enough water to cover. Bring to a simmer over medium heat, then reduce heat and continue to simmer for 11 minutes. Transfer the eggs to a bowl of ice water. When the eggs are cool, peel and serve.). A group of specific recipes intended to be served together therefore constitutes a meal (e.g., Prosciutto-Wrapped Chicken Breasts with Flash-Fried Green Beans and Creamy Parmesan Polenta). A recipe may include a recipe ingredient list, which may be a section of text that lists the basic materials used in a recipe, each of which may be referred to as a recipe ingredient. The recipe ingredient may be a single component used in a recipe, which typically includes a quantity or amount, and may include advance preparation (e.g., 1 large onion, peeled and cut into 8 wedges.)

As explained herein, the present description enables meals to be automatically generated based on user preferences, settings, constraints, and various other data and information. The user-defined settings may be associated with a specific meal and/or recipe, and direct how that meal or recipe should be used when automatically generating a meal plan. The meal plan refers to a list of specific meals assigned to meal slots on one or more days (where a single specific meal having been assigned to a meal slot on a date may be referred to as a planned meal). The meal slot refers to a generalized time or form of eating on a specific day at which the food consumer would eat (e.g, Dinner, Nov. 2, 2011; or Snack, Nov. 20, 2011). As such, an example meal plan may be: Cobb Salad for Dinner on Nov. 2, 2011.

Meal preferences and meal slot constraints are represented at 108. Initial default settings may be supplied with the system, and can be modified by the user as described herein. The meal preferences and meal slot constraints may be of various forms and may include limitations on time of day, day of the week, time of year, season, ingredient exclusions, requirements for certain recipes to be served together (or never served together), a reoccurrence frequency setting, combinations thereof and various other features as will be described herein, such as with regard to FIG. 5. One example preference could be: Butternut Squash Risotto should be planned often, only during the seasons of fall and winter. For example, the meal slot constraints may include rules or limitations the user places upon a given recurring meal slot or set of meal slots, for what constitutes an acceptable meal assignment. For example, the constraints may even relate to preparation time (e.g., the user may specify that on weekdays, dinner must take no more than 30 minutes total preparation time). As another example, a user may designate their personal desire to eat Cobb Salad “Frequently”, and their need to plan the dinner meal slot every night, but the lunch meal slot only on weekends, since these are the times the user cooks at home rather than buying food at work or school, or eating out.

As still another example of preferences or constraints that can affect the generation of a meal plan, the system may include a recipe queue defined by the user, or included with default settings. The recipe queue may be a predefined list of recipes and/or meals specified to populate a meal plan according to a designated sequence. For example, a user may specify that the following meals/recipes be scheduled into a meal plan in the following sequential, possibly contiguous, order: Chicken Pad That, followed by Macadamia-Crusted Mahi Mahi, followed by Grilled Cheese and Tomato Soup.

Similarly, a recipe set may be defined by the user, with the set including a predefined group of recipes and/or meals intended to be incorporated into meal plans in a certain way, illustrated at 106. The designated recipe subsets 106 may include specialized collections of recipes that reflect shared characteristics or use, such as “Sunday Dinners” or “Quick Gluten-Free Meals”. Recipe subsets may be supplied with the system, created by the user, or some combination of the two. Defining recipe subsets allows a user to direct that a certain kind of meal should be planned at a given meal slot, without having to select this manually. As noted above, selected recipes and/or meals may be specified as “Sunday Dinners” indicating that they should be scheduled only on a certain day (e.g., Sunday), and only for a specified meal slot (e.g., the dinner meal slot).

Continuing with FIG. 1, a meal scheduler 110 is shown including instructions and/or code to automatically generate a meal plan taking into recipes and meals in the recipe database, recipe subsets, meal preferences, and meal slot constraints. The meal scheduler 110 further includes instructions and/or code to generate a meal plan suited to these settings that can be presented as a suggestion to the user, or automatically set as the determined meal plan 112.

Meal plan 112 includes the selected recipes and/or meals for designated meal slots in the past, present, and/or future as compared with the current date and time. This may be system-generated, user-chosen, or a combination of the two as explained.

The system may also include a notifications engine 114 that can alert the user when it is time to begin preparing a planned meal, or when other events have occurred such as the availability of new recipes for download. Mealtime notifications can be performed based on various factors, such as a duration for meal preparation. As one example, the notifications may be based on a total preparation time required for a planned meal's recipes, counting backwards from the desired meal time so the user is alerted at the time they would need to begin cooking, to have dinner on the table at the desired time of day.

The system may further include a shopping list 116 that can be generated from the ingredients of recipes in the generated meal plan, from manual user entries, or from a combination of the two. The shopping list sets forth one or more shopping list items, including food or other household items, needed for the recipes in the generated meal plan 112. Further, user entries may be captured as a one-time addition (user realizes they are out of balsamic vinegar so they add it to the list even though it does not appear in an upcoming recipe) or added as a recurring shopping list item (e.g., it can be specified as “always on the list”) such as eggs, something the user always buys or considers buying, since it is so commonly consumed.

Management of the shopping list 116 may be performed in a variety of ways. As one example, shopping settings 118 may considered that contain both universal (applying to all users) and user-specific configurations that control how the shopping list is managed and displayed. The shopping settings may include persistent entries in the shopping list (e.g., “always buy” items), controls for how the shopping list is to be regenerated when the meal plan changes (automatically or only when the user directs an update), or settings for the naming and ordering of store departments (e.g., produce is encountered before dairy since that is the order a given user prefers to walk through the store).

Finally, system 101 may include ingredient keywords list 120 further described with regard to FIGS. 6-7. The ingredient keywords list includes rules for organizing shopping list entries into store departments, and the capability to exclude or deemphasize certain items known to be generally available in the user's cooking environment (e.g., “never buy” items). Grouping entries by store department allows users to move efficiently through the store, completing all items from one department before moving to the next area. By recognizing such items that should (almost) never be added to the current shopping list (e.g., salt, which will not typically be purchased on regular store trips even though it appears in Planned Meals), the system can hide or deemphasize those items so that the user reading the shopping list at the store can focus on what they actually need to find and purchase.

While FIG. 1 presents several general concepts, additional details are provided in the following figures, including FIG. 2, which describes a distributed device architecture. Specifically, architecture 200 shows a multi-device and/or multi-application deployment where the same user (or user account, meaning multiple users of the same household) can share and manage information and settings across more than one device or interface point. The various communication lines between the devices represent data communication paths for the devices to transmit and receive information as described herein.

Specifically, FIG. 2 shows a plurality of devices (e.g., 202 and 206) and web application (210) that can each interact with, and synchronize with, a remote centralized storage or other cloud service 214. Note that this is just one example configuration and numerous others may be used, if desired.

The devices 202/206 may be any computing device such as a cell phone, Smart Phone, Personal Digital Assistant, Tablet, Laptop computer, Desktop computer, etc. Its components are consistent with computer system 101 and only partially repeated, although each device may further include a synchronization service 204, 208, 212, respectively. The devices each have the capability of transferring information to and from a remote storage location, for purposes of backing up the information to protect it in case of device loss or failure, and also to propagate the device's information and settings to other devices or interface points to make the information more accessible. This synchronization process may occur synchronously (in real-time as the edits are made, they are immediately transferred to the Remote Storage service), or asynchronously (meaning that changes reside on the device only until a later time when the device and remote storage service connect and resolve differences).

The benefit of this system and method to the User will be enhanced if the device is movable, such that the process of planning meals and shopping for groceries can be done seamlessly as an individual goes from home environment to store. However this is not required, as the device may generate a meal plan and shopping list while the user is at home, then print the shopping list from a desktop printer and take the printed list to the store. In this way, it may be possible to synchronize information across multiple devices to allow the process to be separately delegated (one person manages meal plan generation while another shops based on a list generated from that meal plan), and provides greater information accessibility (the same user generates a meal plan on a computer at home, then takes a smartphone to the store to shop).

As mentioned above, the distinct devices in FIG. 2 may belong to different members of the same household such as a spouse, son or daughter, or staff such as a personal chef.

As mentioned above, beyond self-contained computing devices, other methods such as a website interface via web application 210 may allow a user to access the same information and functionality as the aforementioned computing devices. For example, it can be inconvenient or time-consuming to enter recipes via some devices, especially when undergoing an extensive task like typing in a large number of recipes. Such tasks can be made much easier and faster by providing a website interface which allows a user to use a full keyboard and large computer monitor. The web application 210 may be a web service, providing the stated actions and operations by responding to incoming programmatic requests rather than through a direct user interface as with a typical website.

Remote storage 214 may communicate with a plurality of the devices in order to keep one household's information consistent across multiple devices and interface points. The remote storage 214 may include a centralized storage service or location to act as a single system of record. If a new recipe is added on one device, it can be sent to the remote storage service, where it is then available to other devices at the next time synchronization. Using a remote computer server as the system of record (rather than designating one device as the master device) may allow for high availability and reliability, since computing devices may be turned off or go out of range of wireless connectivity which is required to respond to incoming requests.

Referring now to FIG. 3, a routine is described for managing the overall meal generation and shopping operations, including the actions performed in order to arrive at a meal plan with ingredients purchased and the food prepared. The routine of FIG. 3, and other figures herein, may be implemented via the system of FIGS. 1 and/or 2, for example.

First, at 300, the routine defines a set of recipes viable to be placed on a meal plan. This may occur by physically storing the desired recipes in a database, or by tagging or categorizing recipes from a larger database either on the computing device or stored elsewhere. This raw list of available recipes may be remotely stored and managed by a remote service, with the same list of available recipes made available to a large number of users. In some examples, the user may select a particular service for supplying the set of possible recipes.

At 304, the routine groups recipes into meals. For example, based on user input, the routine may combine recipes into meals. For instance, the user may designate that Pot Roast be grouped together with Mashed Potatoes and Stewed Carrots, because of flavor compatibility, or the convenience of cooking the carrots and the Pot Roast in the same dish. Alternatively, or in addition, the routine may automatically combine certain recipes into meals based on information in the recipe database regarding compatibility among recipes as well as compatibility among preparation methods and preparation devices and utensils (e.g., oven vs. microwave, or whether two recipes each require a food processor). For example, recipes each utilizing the oven at a common temperature may be grouped together in a meal, whereas recipes requiring the oven at substantially different temperatures (e.g., greater than 100 degrees F. apart) may not be grouped into a meal.

Next, at 306, the routine meal preferences are specified, such as described in further detail with regard to FIG. 5. This action may be performed responsive to user input, or by the author/source of the recipes as originally provided. Meal preferences may include the desired frequency of a given meal, seasonality (meal should be planned only in Spring), and portion multipliers (where the user designates that a given meal's recipes need to be doubled to provide enough food for his/her family). Meal preferences may be applied to individual recipes, or to a designated meal that may bring together multiple recipes.

Continuing with FIG. 3, at 308 the meal slot constraints are specified, again as described in further detail with regard to FIG. 5. As explained herein, an example meal slot constraint is that dinners should be planned on all days of the week, lunches only on weekends, and that weekday preparation time should be limited to 20 minutes.

At 310, the routine plans recipes for a given time period, such as for today and a user-selected number of days to follow. For example, the routine may assign recipes and meals to meal slots while taking into account the preferences and constraints of 306 and 308 by selecting recipes and meals from the defined set of 302 and/or 304. Alternatively, the routine may present a suggested meal plan to the user, receiving any modifications from the user at 312. For example, the user may be interested in planning a meal that the system cannot automatically consider or predict. In reviewing the automatically-generated meal plan, the user may remember that Tuesday evening is a dinner party, so no meal needs to be planned for that day. Users may also enter a request to swap a meal from one day to another, or that one or more meal slots be re-planned by the system since they don't seem appetizing at the time, or they seem overly complex, etc. As such, the user may request re-planning of only a sub-set of the meal plan based on further criteria.

The user may specify via settings how far in advance to plan, since situations may vary. For someone who lives in a rural location far from a store, they may wish to shop for over a week of meals at a time. On the other hand, a user who lives or works very near to a grocery store may shop every 2-3 days, and therefore may only plan meals for 2-3 days in advance. Further, a user may plan just a single meal for today only, if dinner is fast approaching and he/she only has time to shop for and prepare this one meal.

Continuing with FIG. 3, at 314 the routine generates a shopping list based on the planned meals, and displays the generated list to the user. The routine may take every recipe ingredient from each planned meal, and place it on a shopping list, and further may indicate a quantity of the ingredient needed based on the meal plan, as well as based on user data on the desired size (e.g., number of persons to be fed) of the various meals. FIGS. 6-7 describe additional operations and additional details of the shopping list generation. Next, at 316, the routine receives any user additions to the shopping list, or merges other user generated shopping lists into the shopping list 116. For example, a user may add items not present in planned recipes, (e.g., Diet Soda or non-food items like lightbulbs). By default, all shopping list entries appear as unchecked items, ready to be checked off by the user to indicate that they have been purchased or else located in the kitchen or pantry.

At 318, based on the user's desired eating time for a given meal slot, the system can count backwards from that time by the total number of minutes required to make each recipe planned for a meal slot on a given day. The user may define a different eating time for the same meal slot on different days, or they may vary depending on weekend vs. weekday, or based on other factors such as the season to account for different sunrise/sunset times. The system can alert the user with a message box, sound, or vibration, so that the food can be finished on time. This can be extremely beneficial to some home cooks, since some meals may take as long as two hours while others take only 30 minutes, so there is no set time of the day at which a person can simply remember to start food preparation, even if eating times are predictable.

At 320, since the meal plan and recipe information is available on the computing device, some users may bring their device into the kitchen to cook, while others will print the Recipes, and others may cook from memory.

Turning now to FIG. 4, it sets forth additional details of the meal plan generation of 301, including the system logic for automatically setting or suggesting which meals will be planned for unplanned meal slots. Specifically, at 402, the routine receives the user meal slot constraints of which meal slots are to be planned on which days. This may be a weekly schedule, monthly, etc. These constraints may further include a user's designation of how many days into the future to plan. For example, the system may receive a user setting to plan lunches and dinners for today and the following 3 days.

Next, at 404, the routine begins with the first needed unplanned meal slot in the future. The first unplanned meal slot might be for the current day, or may be some days in advance if all meal slots for today and subsequent days are currently already planned. At 406, the routine determines applicable meal slot constraints. For example, the meal slot constraints for a given meal slot may dictate a maximum total preparation time, or that meals must come from a designated recipe set (e.g., “Sunday Dinners”). Additional details of the constraints are set forth in FIG. 5, for example. At 408, the routine then identifies meals that meet the constraints for the meal slot being planned. For example, the routine may determine which meals meet preparation time requirements, specifically that certain days of the week require meal preparation (active preparation time, and/or total preparation time) to be under a certain user-defined threshold. For instance, someone who cooks dinner after returning home from work at 5:30, may set a maximum preparation time for weekday meals at 30 minutes, to serve dinner by their set dinner time of 6 pm. Meals requiring over 30 minutes total time would be excluded for these meal slots by the automatic generation.

At 410, the routine then selects a meal based on meal preferences and universal planning rules and assigns it to the meal slot being planned. The universal planning rules may be based on a variety of approaches, including random, weighted assignment. Further, the routine may take into account a desired frequency for each meal or recipe so that those meals with a higher desired frequency have more chances of being chosen than meals of a lesser desired frequency. Alternatively, meals or recipes can be assigned with complete randomness; or else a recipe queue can be established which pre-defines the order of meals or recipes in a cyclical list as explained with regard to FIG. 1. Further, universal planning rules may include other restrictions, such as specifying that a given category of meal, recipe, or ingredient, should never repeat from one day to the next, so that users do not get bored with the same type of meal (e.g., beef) over and over. For example, an automatically generated meal plan may include a first meal including a first set of recipes at a first meal slot on a first day, and a second meal including a second set of recipes at a second meal slot on a second day, wherein a main meat ingredient in the first set of recipes differs from a main meat ingredient in the second set of recipes, wherein the first and second meal slots are common meal times.

Then, at 412, the routine presents the meal plan to the user. As explained above, the system-generated meal plan may be automatically accepted, reviewed by the user to determine if they will choose to accept it, or consider it just a suggestion which may require a number of manual adjustments by the user (switching meals from one day to another, removing a planned meal entirely, requesting a new system-generated assignment for a given meal slot) before the user accepts the meal plan and saves it for use in the shopping list generation described further with regard to FIGS. 6-7.

Referring now to FIG. 5, various meal planning preferences and constraints 500 are illustrated. In this example, FIG. 5 schematically represents three categories of user-defined settings that can affect the automatic generation of meal plans. Some settings are applied universally via universal planning rules 502 in that they apply to all users, meal slots, and recipes). The meal slot constraints 510 typically describe the user's needs for meal planning and are applied accordingly. Finally, the settings also include meal preferences 524, which are typically settings specific to individual recipes and meals in the recipe database. However, still further user-settings may also be applied, if desired.

As illustrated in 502, the universal planning rules may apply to all users of the system, although the system may provide the ability for individual users to override or modify these rules. At 504, the system may enable the user to enter meal category repetition settings, such as to avoid such repetition. For many users it will be undesirable (repetitive or boring) to eat the same type of meat ingredient (Beef, Pork, Chicken, Fish) for multiple meals in a row (breakfast, lunch, and dinner on the same day), or for the same meal slot on consecutive days (Monday dinner and Tuesday dinner). As such, the system may receive a user setting or include a default setting that specifies the automatic meal generation should avoid sequential repetition of the same ingredient or group of main ingredients of a meal on meals in the same day, and consecutive meals at the same meal slot from day to day. Another example is that the same style or type of cuisine, such as Italian, may be undesirable if similarly repeated in subsequent meals or on the same meal slot on consecutive days. As such, the system may also receive a user setting or include a default setting that specifies the automatic meal generation should avoid sequential repetition of the same style or type of cuisine of a meal on meals in the same day, and consecutive meals at the same meal slot from day to day.

Likewise, recipe repetition settings are also received from the user via 506. Again, most users do not want to eat the exact same recipes for multiple meals in a row (breakfast, lunch, and dinner on the same day), or for the same meal slot on consecutive days (Monday dinner and Tuesday dinner). As such, the system may receive a user setting or include a default setting that specifies the automatic meal generation should avoid sequential repetition of the same recipe for meals in the same day, and consecutive meals at the same meal slot from day to day.

As noted above, the universal planning rules may include a frequency weighting, again from the user or as a default setting. Such data adjust the automatic selection of recipes to generate the meal plan described in FIGS. 3-4 such that some meals, or meals with selected ingredients, would be planned more often than others. For example, the routine may specify that meals marked “Often” should appear in a meal plan five times more often than meals marked “Rarely”.

Turning now to the meal slot constraints 510, various examples are shown at 512-522 illustrating constraints corresponding to the needs and desires of a given user for different times of the day and days of the week, or to system settings which are applied to approximate the needs of all users as a starting point or ongoing. Constraints 512 designate which meal slots (Monday breakfast, Monday lunch, Monday snack, Monday dinner, Tuesday breakfast, etc.) should be populated by the system through the automated meal scheduler (FIG. 1). The constraints may also include received user settings to automatically plan meals from a designated recipe set, such that Sunday dinner is always chosen from the “Sunday Dinners” recipe set. Constraints 514 designate which meal slots (Monday breakfast, Monday lunch . . . ) should be populated based on a designated recipe queue, where the next meal or recipe in a sequence will be used. Again, the system may receive user settings specifying the recipe queue, as well as which meal slots it should be applied to when automatically generating the meal plan.

Meal slot constraints may also include pre-set meals 716. For some users, they may desire that certain meal slots will be handled the exact same way every week. For example, a user may specify a certain weekday dinner (e.g., every Thursday) as having a pre-set meal, such as pizza (where Thursday is then referred to as “Pizza Night”). In this case, the system will automatically constrain the Thursday dinner meal slot as pizza and prevent any other recipe or meal from being planned at that time (unless the user manually changes the constraint or changes the meal plan at 412. In another example, a pre-set meal may include a specific meal or recipe chosen by the user that is repeated more or less exactly (Example: Chicken Fajitas every other Thursday dinner). The pre-set meals may also include settings that certain meal slots should not be planned.

Additional constraints that may be received in the system and used when automatically generating the meal plan relate to preparation time, as represented by 518 and 520. For certain meal slots, a user's schedule may require a limited amount of time preparing a meal. For instance, a user may specify a constraint that limits the active preparation time (e.g., the amount of time where a user actually performs food preparation tasks, thus requiring the user's attention) to 20 minutes for weekday dinners, but with no limit on weekend dinners active preparation time since they have more time to spend in the kitchen on weekends. As indicated above, active preparation time only considers the minutes during which the cook is working on preparing food, and does not include the time the food may continue to cook on the stove, cook in the oven, chill in the refrigerator, etc. in which the cook does not need to attend to the food.

Additionally, the system may receive a user specified limit for selected meal slots relating to the total preparation time, including not only the active preparation time, but also any remaining cooking, chilling, or other un-supervised time needed to prepare a recipe or meal. For example, a user's schedule may require them to limit the amount of total time between the start of food preparation, and the time it is ready (e.g., if they need to eat at 6 pm but only get home at 5:30, total preparation time may be limited to 30 minutes).

There may be scenarios where the active preparation time constraints and total preparation time constraints should not apply, and thus the system may include overrides at 522. For example, a user may specify certain recipes with an override designation, such as “Slow Cooker” or “Make Ahead.” In this case, the preparation constraints may be overridden when the system automatically generates the meal plan. An example of a Slow Cooker recipe is a Beef Chili Recipe that can be put together in the morning and allowed to slowly cook unattended throughout the day, so that it is ready to eat for dinner. If a User specifies a limit of 40 minutes of total preparation time, this would be overridden for recipes and/or meals having the designated override setting. In other words, even though total Preparation time for the recipe is 9 hours, the recipe may be available to be added to the specified meal slot. Further, in this case, the routine may include a notification, as discussed below, 9 hours ahead specifying that the recipe be started.

The user-defined preferences may also include meal preferences 524, which may include settings associated with specific meals and/or recipes in the recipe database, designated as 526-536. The desired recipe frequency setting 526 include settings configurable by receiving an input from the user that, for a given meal or recipe, that meal or recipe may be desired more often, or more rarely than others. For example, in a given household, Grilled Cheese and Tomato Soup may be a popular meal which can be designated with a setting of “Often” so that it will be automatically scheduled more often in a given meal plan. Other example frequency settings that may be used include “Sometimes”, “Rarely”, or “Try Once” (for a new recipe which a user may plan to test). Some recipes may be given a Frequency of “Never” meaning that it should remain in the recipe database for reference but should never be automatically added to a meal plan. In its simplest form, the frequency settings can be merely tagging selected recipes as belonging to group (e.g., “my current recipe box”, or “my favorites”) that is used to automatically generate meal plans. In this scenario any recipe in the group tagged in this way is can be assumed to have a selected frequency of “Sometimes” while every recipe not tagged in the same way can be assumed to have a frequency of “Never.” Still other approaches may be used, in combination with those noted herein, to populate a meal plan from available recipes and/or meals meeting a group of preferences and constraints, with certain recipes being selected more frequently based on other factors, such as a desire to deplete a certain stored food substance as indicated by a user.

Another meal preference set forth in FIG. 5 includes seasonality preferences 528. Such settings enable the system take into account the fact that many foods are more available, less expensive, and of better quality, at certain times of the year, when automatically generating a meal plan. Similarly, certain preparation methods are better suited to particular times of the year, as some users may desire to minimize use of recipes requiring a hot oven in order to avoid making the kitchen and house uncomfortably warm. Specifically, the seasonality settings are received by the system enabling a user to designate a recipe or meal with one or more most appropriate season or month. If the user has populated this setting (or it is otherwise automatically populated from other information or default settings), the recipe or meal is available to be selected in meal slots that occur only during the designated season or month. This will allow the meal plan to be populated with more recipes listing fresh leafy produce in the summer and fall seasons, and with more recipes listing root vegetables (e.g., beets and carrots) in the winter.

At 530, the system may include an advance-purchase time limit. This preference setting enables the system to preferentially schedule recipes or meals in order to have the meal scheduled in a meal slot within a certain time limit from the date the ingredients (or certain selected ingredients designated by the user) are purchased. For example, some meals use ingredients that will keep in storage for only a limited duration. As such, the system enables the user to specify how long in advance the purchase of one or more particular ingredients could be made. The setting could also be applied to a meal. In this way, the system can then take the time limits into account when automatically scheduling a meal plan such that a meal whose ingredients will only last for four days, is not planned for a meal slot which is six days in the future, or six days past a scheduled shopping trip.

Continuing with FIG. 5, meal type preferences 532 enable a user to designate that certain meals are appropriately served for breakfast, others for lunch, and in some cases meals may be suitable for more than one meal type. This enables the user to specify their preferences for which recipes are appropriate for which meal slots, and enables the system to generate a meal plan with socially-appropriate and nutritionally-appropriate meals.

As explained herein, recipes or meals may be associated with a particular recipe set, such as “Sunday Dinners,” via the setting 534, and further, recipes or meals may be associated with particular recipe queues via the setting 536.

In this way, it is possible for the system to receive various user-defined preferences and constraints and generate a meal plan with meals and recipes that satisfy these constraints.

Referring now to FIGS. 6-7, additional details of the shopping list generation and management (314-318 of FIG. 3) are provided. Specifically, FIG. 6 sets forth a routine 600 for categorizing recipe ingredients for shopping. This routine organizes a list of detailed ingredients by store department based upon a configuration of stored keywords. In particular, the routine assigns each ingredient to a stored category, such as Produce, Meat, Deli, Canned Goods, etc., based on ingredient keywords and keywords exclusions.

In one example, the routine largely treats each recipe ingredient as a string of text that can be processed by a text engine aiming to identify certain words or combinations of words designated as ingredient keywords. The presence of ingredient keywords in an ingredient text of a recipe indicates that that ingredient can be associated with the category assigned to the keyword. By recognizing ingredient keywords, the routine can group shopping list entries into store departments, and hide or de-emphasize certain ingredients in a shopping list. Such an approach may provide an efficient shopping experience for the user, without requiring each recipe ingredient to be entered into a database of “master ingredients.” The advantage of a keyword approach (rather than tying recipe ingredients to a master ingredients list), is that it simplifies the addition of new recipes, which would otherwise need to be associated, ingredient by ingredient, to a corresponding master ingredient.

Such an approach can be contrasted with applications that generate shopping lists from recipes by requiring that each recipe ingredient first be deconstructed into parts such as quantity, units, description, and preparation, where the description or core raw material of an ingredient may further be tied to a central list of ingredients.

Referring now to FIG. 6, at 602 the routine separates the recipe ingredients list into individual ingredients based on delimiters such as new line/carriage return. For example, placing each recipe ingredient on its own line of text is a very common convention for the formatting of recipes. HTML tagging standards provide another example way that may be used by the routine in delineating where one recipe ingredient ends and another begins, as these standards are being increasingly adopted by online food websites and writers.

Next, at 604, the routine determines, for each recipe ingredient, whether any of the configured ingredient keywords exist within its text, without using a specified keyword exclusion. For example, each recipe ingredient may be processed separately to determine whether ingredient keywords are found within its text, and if so, whether keyword exclusions associated with this ingredient keyword are also found (which would negate that match). The keyword exclusions thus include one or more words associated with an ingredient keyword, whose presence within the text of a recipe ingredient indicates that this is not the food item the keyword ingredient might otherwise imply. The keyword exclusions approach accounts for a simple word or phrase (e.g., “flour”) that might imply that this recipe ingredient would be found in the baking section, while also accounting for false positives (such as “flour tortillas”). Thus some ingredient keywords (e.g., “flour”) may be listed with an associated keyword exclusion (e.g., “flour tortilla”).

As such, continuing with FIG. 6, at 606 the routine determines whether ingredient keywords exist in the recipe ingredient's text, without the keyword exclusion(s). Depending on the outcome, a found ingredient keyword is only considered a match by the routine if the corresponding keyword exclusions are not found. Thus, if no match is found, the routine continues to 608 and the recipe's ingredient is tagged with an unknown store category. For example, it may be difficult for the routine to include information that anticipates all possible ingredient keywords.

Alternatively, if more than one match is found, the routine continues to 610 to determine which of the matching ingredient keywords is designated as the best match (e.g., most specific/exact text match). For example, the routine may specify pre-determined tie-breaker decisions, such as that the Produce department has preference over the Canned Food department if both match an ingredient. As such, in this example, each recipe ingredient may be mapped to only a single store category, or else unknown. Another example may allow a single recipe ingredient to be associated to multiple store categories (for example, Organic Milk may tagged with both the Dairy and Natural Food category, as it may be found in either location).

In one example, the routine may also determine a degree of the keyword match, referred to as keyword exactness, in determining which match should be selected if multiple matches are found. The keyword exactness may represent a numerical ranking among all ingredient keywords of how confidently the system should trust a match on that text, when multiple keyword ingredients are matched in the same recipe ingredient text. As another example, the routine may also identify the best match based on a keyword specificity ranking, which is a method of sequencing ingredient keywords in order of how confidently the system should trust a match on that text, when multiple keyword ingredients are matched in the same recipe ingredient text. For example a recipe ingredient such as “sugar free chocolate pudding” might match keywords of “sugar free chocolate” and also “chocolate pudding”. In this case the “chocolate pudding” keyword would have a higher specificity ranking (1105 for example) so that its store department would override that of “sugar free chocolate” (specificity ranking of 847 for example) since the latter could be found in a variety of store departments and therefore is less exact.

Based on a single match, or after determining which store category was the best fit for multiple matches, the routine continues to 612 to designate the recipe ingredient as belonging to the matched (or best matched) ingredient keyword's designated store category. The process repeats until each recipe ingredient is associated to a single store category, or else designated unknown. Specifically, at 614, the routine determines whether all recipe ingredients been assigned a store category (including unknown). If so, the routine ends. Otherwise, the routine returns to 604.

Referring now to FIG. 7, a routine 700 is described for filtering out ingredients for shopping in order for the routine to generate a more efficient shopping list. First, at 710, the routine separates the recipe ingredients similar to 602 of FIG. 6, and then determines at 704 if any of the configured ingredients exist similar to 604 of FIG. 6. Next, the routine utilizes the list of separated recipe ingredients, and applies user-defined shopping settings to determine which items should be hidden or de-emphasized on the shopping list displayed to the user (e.g., the user designates them always available in their cooking environment). This determination is based on one or more shopping settings, a list of items which the system and/or user has designated “Never Buy”, stated in the form of ingredient keywords with corresponding keyword exclusions, for example. Specifically, a never-buy keyword may include one or more words, or other identifying tag, whose presence within the text of a recipe ingredient may indicate that the item does not need to be purchased since it can be confidently assumed to be always available in the user's cooking environment. Further, a never-buy keyword exclusion represents one or more words, or other identifying tag, associated with a never-shop-for keyword, whose presence within the text of a recipe ingredient indicates that this is probably not the food item which the never-shop-for keyword might otherwise imply. For example, a never-buy keyword may be “salt” but the term “celery salt” may be excluded.

In one example, the presence of a “Never Buy” ingredient keyword is not considered a match unless the ingredient keyword is found in the recipe ingredient text, without any associated keyword exclusions. The keyword exclusions approach compensates for the situation where a word or phrase like “salt” might imply that this recipe ingredient exists in the user's pantry and does not need to be purchased, but there could be many false positives such as “kosher salt” which may not be available in the user's home cooking environment.

Specifically, at 706, the routine determines, for each recipe ingredient designated as “Never Buy” by the user, whether never-buy keywords exist in the recipe ingredient's text, without a corresponding keyword exclusion(s). If one or more matches is found, the routine continues to 710 to designate the recipe ingredient as a “Never Buy” item and thus exclude it (or place it in a special category) during shopping list generation. Otherwise, the routine continues to 708 to not designate the recipe ingredient as a “Never Buy” item and thus include it in the shopping list generation of 314.

The routine then repeats via 712 for each recipe ingredient. In this way, the routine can generate, and display to the user, a more efficient shopping list by properly excluding items designated by the user as always available in the kitchen. Specifically, the shopping list generated and displayed to the user (including the listed ingredients, their associated store category, the quantity needed, etc.) may be based on the categorizations and exclusions determined in FIGS. 6-7.

Referring now to FIG. 8, an example data structure for the various parameters is set forth. Specifically, FIG. 8 illustrates example data structure 800 including data entities and attributes, and structural relationships between the data. While FIG. 8 illustrates one example structure that may be used with the routines of FIG. 3, for example, various other data structures may also be used.

Data structure 800 defines the user's data that may be stored on a user's mobile device, remotely, or combinations thereof. The data comprises month data 802 including the month number (e.g., integers 1, 2, . . . ) that uniquely identifies each record while the month name includes a string that fully spells its text label (January, February) and the month abbreviation includes a string that condenses this text (e.g., Jan, Feb, . . . ) for situations where it may be displayed in limited space. Similarly, seasons data 804 may also be used, including a string name for the season and an integer season sequence to order the seasons in time. As explained herein, the seasonality of recipes or meals could be specified in a broader sense (e.g., winter recipes, summer recipes . . . ), or in a more granular fashion using specific months (e.g., Strawberry Shortcake in June but not July and August (since the local strawberry season does not last all summer)).

Meal data 806 includes data to distinguish each meal via an assigned numerical identification number, as well as a string name. The unique numerical identifier may not be visible to the user, but will enable the system to uniquely identify each meal. The meal data 806 further includes a decimal number that represents a default portion multiplier, indicating how many times the quantities of associated meals or recipes should be multiplied in order to adequately feed the typical household for which the user cooks, as entered by the user. For example, the user may specify the number of adults and/or children for which the meals are typically prepared, and such data, along with the portion multiplier for each recipe, enables the system to specify to the user a quantity of one or more ingredients corresponding to their desired meal size. For example, the system may present the user with such information when shopping (see FIG. 3, 314) to ensure that they purchase enough food. The name of a meal may be the same as its associated recipe(s), or it may have a special name that summarizes its contents, such as when “Dad's Favorite Roast” incorporates multiple recipes by different names. The meal data may also include a creation time stamp for each meal, as well as a modified time stamp, to indicate the most recent modification to the meal.

Meal frequency data 808 lists the different options for how often a meal might be desired (example descriptions (as strings) include Often, Sometimes, Rarely, Try Once, Never, selected by the user), along with their relative weighting as a decimal (see FIG. 5).

User data 810 lists each individual user using the system via a numerical identifier, and may include their name, email address, password, etc. Additionally, or alternatively, the user data 810 may represent a single household with multiple users who wish to share the same account and associated meal, recipe, and other such data and settings, including common preferences and/or constraints. Such an approach is particularly advantageous when the multiple individuals share meals together and thus each person's preferences and/or constraints may be relevant to the meals served jointly to the group. In this case, each of the persons in the group may have a unique identifier and may each access/modify some or all of the preferences and/or constraints, as well as other portions of the system.

Recipe data 812 includes data for each recipe, including a uniquely assigned numerical identifier (e.g., integer) to allow the system to uniquely identify each accurately, despite seeming duplicate entries such as two recipes both titled “Chicken Cordon Bleu” which despite sharing a name may have different ingredients, instructions, and associated meal preferences. Various text fields are stored here as indicated in FIG. 8, including the headnote where a high-level introduction, story, anecdote, warning, or other piece of advice may be kept for recipes. A recipe source field may be included that tracks the source from which each entry originated, whether included with the system, captured from an on-line site, entered manually by the user, etc. The portions served integer number data captures how many people can typically be fed with one preparation of the recipe as stated. This can be used by the system to calculate what number to multiply the listed ingredient quantities by, in order to display a desired quantity for purchase in the shopping list, based on a user specified number of individuals the user anticipates feeding. The recipe author lists the individual or organization who published or provided a given recipe, if known. Again, various time stamps may also be stored for each recipe.

Meal type data 814 stores information specifying, via a numerical identifier and string description, the type of meal, such as “Breakfast.” However, the data may include information beyond common entries of breakfast, lunch, and dinner, including identifiers such as: snack, dessert, appetizer, etc.

Planned meal data 816 stores designated data for each planned meal, as well as a meal type and a direct association to one or more recipes which will be prepared at this time. The planned meal data 816 does not link directly to the meal data 806 in this example, since a user may choose to manually edit the specific recipes that typically belong to a meal, without affecting the combination of recipes that make up the stored meal captured in the recipe database.

Recipe category data 818 includes an integer numerical identifier for each recipe category, as well as a string name and an integer sequence. In this way, recipes will be logically grouped according to similarities, such as Salads, Poultry, Quick Breads, etc.

Photo data 820 may include one or more images associated with a recipe to represent the finished look of a dish, or the preparation which precedes the finished product. Further, string captions may be stored for each photo.

Shopping list item data 822 includes numerical integer identifier data to uniquely identify each shopping list item, stored with a string name, for example. Since shopping list items may originate from a planned meal, or from a manual addition by the user, the system tracks the origination (e.g., “manual add ?” Boolean data) so that the system can properly adapt to changes in the meal plan. For example, if “4 ounces sliced Prosciutto” is included on the system-generated shopping list because it is planned as Monday's dinner, while “lightbulbs” was entered manually, and if the user then deletes the planned meal from Monday evening, the system can remove prosciutto from the displayed shopping list, while retaining the lightbulbs (since the need for the lightbulbs was not tied to a meal plan). Such actions by the system are enabled via the shopping list item data 822 and the overall data structure 800. Similarly the system may track which items the user has marked off the list as purchased (e.g., “purchased ?” Boolean data).

Ingredient keyword data 824 includes various parameters on the ingredient keywords (as described with regard to FIGS. 6-7), including numerical integer identifier data, string data on the keyword text, exclusion strings, specificity ranking integer values, as well as whether a particular ingredient is specified by the user as always needed, or never needed (Boolean data). Store department data 826 includes an integer numerical identifier, and string name, for each of the grocery store departments. Further, each department includes sequence data that may be user configurable. For example, the sequence of grocery store departments may be input by the user to suit the order each department is typically encountered when shopping, since different individuals may shop at stores which are laid out differently, or they may prefer to go through in a different order than others. As such, it will be convenient for the user if the device can display their shopping list based on the store sequence data such that items on the shopping list are displayed in the same sequence as they are found as the user plans to proceed through the store.

In addition to the various data of FIG. 8, the data structure 800 further includes particular mapping and linkage between the data as indicated by the lines between each data set. The routine of FIG. 3 (as well as FIGS. 4-7) cooperate with data structure 800 to enable the various actions described herein, as explained in detail above.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method for meal planning, comprising:
receiving a digital representation of a user's meal preferences; and
automatically generating a meal plan including a plurality of separate meals based on the user's meal preferences.

2. The method of claim 1 further comprising automatically generating a shopping list based on the automatically generated meal plan.

3. The method of claim 2 wherein each meal includes a recipe with one or more ingredients, and wherein the shopping list is tabulated in accordance with a store department of the ingredients, the store department determined for each ingredient based on a keyword identification of each ingredient.

4. The method of claim 1, wherein the meal preferences constrain selected recipes for the meal plan based on a current time of a calendar year.

5. The method of claim 1, wherein the meal preferences constrain selected recipes for the meal plan based on a day of the week.

6. The method of claim 1, wherein the meal preferences constrain selected recipes for the meal plan based on preparation time.

7. The method of claim 1 wherein the meal preferences specify a relative frequency for distinct recipes to occur in a meal plan, and where the automatic generation of the meal plan populates the plan more often with recipes having a higher frequency preference than recipes with a lower frequency preference.

8. The method of claim 1 further comprising generating a notification to start meal preparation based on the automatically generated meal plan and a current time of day and a total preparation time for recipes corresponding to an immediately upcoming meal in the automatically generated meal plan.

9. The method of claim 1 wherein the meal plan is automatically generated based on cooking devices included in recipes of available meals, where a plurality of recipes utilizing a common cooking device are automatically scheduled at a common meal slot.

10. The method of claim 1 wherein the meal plan is automatically generated only for selected meal slots on given days, with some days having more planned meals than others in the meal plan.

11. The method of claim 1 wherein the automatic meal generation is further based on a user-defined recipe queue specifying certain recipes to be selected in a pre-defined order in populating the meal plan.

12. The method of claim 1 further comprising receiving adjustments to the automatically generated meal plan from a user, and updating the automatically generated meal plan based on the user adjustments.

13. The method of claim 1 wherein the automatic meal generation is based on a determination of whether meals include repeating ingredients on a common day, or at a common meal slot.

14. A meal planning system, comprising:
one or more physical, non-transitory, devices configured to hold data and/or instructions executable, by a logic subsystem to:
receive a digital representation of a user's meal preferences, including recipe preferences and recipe timing preferences; and
automatically generate an electronic meal plan based on the user's meal preferences.

15. The system of claim 14 wherein the timing preferences include a re-occurrence timing preference and/or a time of year preference, the data and/or instructions further executable to generate a shopping list based on the generated meal plan.

16. The system of claim 15 wherein the data and/or instructions are further executable to receive the user's meal preferences, and to send the generated shopping list to another device.

17. A method for meal planning, comprising:
receiving a digital representation of a user's meal slot constraints and meal preferences; and
automatically generating a meal plan based on the user's meal slot constraints and meal preferences.

18. The method of claim 17 further comprising receiving digital representations of the user's meal repetition constraints, meal preparation time constraints, and meal frequency preferences, and automatically generating the meal plan based on each of the users's meal slot timing preferences, meal repetition constraints, meal preparation time constraints, and meal frequency preferences.

19. The method of claim 17 wherein the automatically generated meal plan is further based on a user-specified or recipe-specific advance purchase limit.

20. The method of claim 19 wherein the automatically generated meal plan is further based on a user-specified maximum allowable preparation time for given meal slots on selected days of the week.
